(19) United States
(12) Patent Application Publication
(10) Pub. No.: US 2008/0077274 A1
(43) Pub. Date: Mar. 27, 2008

(54) Medicine storage cabinet

(76) Inventor: Jun Ho Kim, Taegu (KR)

Correspondence Address: PARK LAW FIRM, 3255 WILSHIRE BLVD, SUITE 1110, LOS ANGELES, CA, 90010, US

(21) Appl. No.: 11/634,411

(22) Filed: Dec. 6, 2006

(30) Foreign Application Priority Data
Sep. 22, 2006 (KR) 10-2006-0092436

(51) Int. Cl. G06F 17/00

(52) U.S. Cl. 700/237

(57) ABSTRACT

A medicine storage cabinet includes a cabinet body that includes a plurality of drawers that contain medicines and a front panel; a biometric identification device that authenticates identity of a user of the medicine storage cabinet; an input device that receives input from an input medium that contains prescription information; a controller that validates user information provided by the biometric identification device, and controls to open the drawer that contains medicine that is prescribed in the prescription information provided by the input device; a monitoring device that takes image of the user of the medicine storage cabinet, a display that is installed on the front panel of the cabinet body and displays medicine and prescription information, and a label printer that is installed on the front panel of the cabinet body and prints out medicine taking out information.

### CLAIMING FOREIGN PRIORITY

The applicant claims and requests a foreign priority, through the Paris Convention for the Protection of Industrial Property, based on patent applications filed in the Republic of Korea (South Korea) with the filing date of Sep. 22, 2006 with the patent application number 10-2006-0092436 by the applicant, the contents of which are incorporated by reference into this disclosure as if fully set forth herein.

### BACKGROUND OF THE INVENTION

The present invention relates to a medicine storage cabinet. More particularly, this invention relates to a medicine storage cabinet that stores important drugs such as psychotropic drugs that require stringent control.

Narcotics like morphine are designated as drugs that require stringent control since there is high likelihood of theft of narcotics. Therefore, taking in and out was allowed only authorized persons, and such persons used locks. A disadvantage was that there was no objective means to verify taking out amount by the authorized person.

An IC card was used to authenticate an operator's identity and to record the name and quantity of medicine that is taken out. The disadvantages of using IC card are that there is a danger that unauthorized user may access a cabinet when the IC card is stolen, and there is still possibility of false recording of the taken out amount by the operator.

A separate administrator who enforces taking in and out of medicines to and from a storage cabinet for a thorough control was required. Real time check of the amount of medicine in a cabinet was not available, and erroneous taking out of a wrong medicine or incorrect amount of medicine was not easily checked.

### SUMMARY OF THE INVENTION

The present invention contrives to solve the disadvantages of the prior art.

An objective of the invention is to provide a medicine storage cabinet that stores important medicine including psychotropic drugs, and that is controlled by electronic means.

Another objective of the invention is to provide a medicine storage cabinet that is equipped with a biometric identification device.

In order to achieve the above objective, the present invention provides a medicine storage cabinet that includes a cabinet body that includes a plurality of drawers that contain medicines and a front panel; a biometric identification device that authenticates identity of a user of the medicine storage cabinet; an input device that receives input from an input medium that contains prescription information; a controller that validates user information provided by the biometric identification device, and controls to open the drawer that contains medicine that is prescribed in the prescription information provided by the input device; a monitoring device that takes image of the user of the medicine storage cabinet, a display that is installed on the front panel of the cabinet body and displays medicine and prescription information, and a label printer that is installed on the front panel of the cabinet body and prints out medicine taking out information.

The biometric identification device is installed on the front panel of the cabinet body, and includes a finger print recognition device.

The input device includes a card reader and the input medium includes an IC card.

The drawer includes a tray and an actuator that moves the tray. The tray includes a plurality of receiving recesses that are adapted to receive receiving cassettes.

The receiving cassette includes a shell that is adapted to contain medicine.

The receiving cassette further includes an RFID tag that records information for the medicine that is contained in the shell. The cabinet body further includes an RFID reader that reads the RFID tag.

A photo sensor is provided in the receiving recess, and checks whether the shell is received in the receiving recess.

A load cell is provided on a bottom of the receiving recess, and measures the weight of the receiving cassette.

The actuator drives a feed screw and a motor. The motor rotates the feed screw, and the feed screw moves the tray linearly.

The cabinet body includes one or more guides that engage with one or more guide grooves provided on the bottom of the tray so that the tray moves along the guides.

The advantages of the present invention are: (1) the security of psychotropic medicine is improved and risk of theft is reduced; (2) recognition of amount and kind of medicine is precisely performed since the receiving cassettes are individually classified and aligned in the tray, and the withdrawal and insertion of the tray is performed smoothly by the actuator; (3) automatic recording of medicine use is performed without a separate recording device, and management of medicine becomes efficient and less burden is imposed; (4) fast and precise monitoring of taking in/out operation is possible with the photo sensor and the load cell; and (5) the display enables immediate check of the medicine information, and the label printer enables prevention of medical accident by incorrect administering of medicine.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a medicine storage cabinet according to the present invention;

FIG. 2 is a perspective view of a drawer;

FIG. 3 is a perspective view of a tray that receives cassettes;

FIG. 4 is a cross sectional view of a shell;

FIG. 5 is a perspective view illustrating operational parts of the medicine storage cabinet;

FIG. 6 is a block diagram showing the method of using the medicine storage cabinet; and

FIG. 7 is a block diagram showing relationship between components of the medicine storage cabinet.

### DETAILED DESCRIPTION OF THE INVENTION

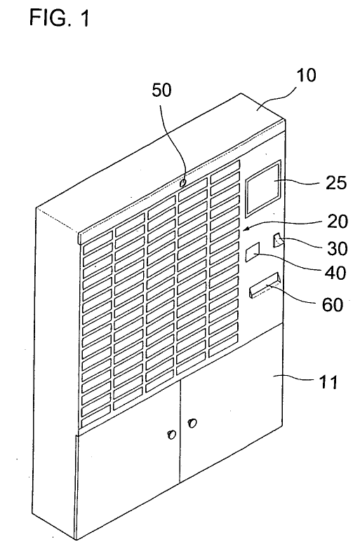

FIG. 1 shows a medicine storage cabinet that includes a cabinet body 10 having a plurality of receiving partitions, a drawer 20 that is installed in the cabinet body 10 so that the drawer 20 is automatically moved out of and into the front portion of the cabinet body 10, a biometric identification device 30 that is installed on the front panel of the cabinet body 10, a card reader 40 that on reads prescription information from an IC card, a monitoring device 50 that is installed on top of the cabinet body 10, and a label printer 60 that is installed on the front panel.

The cabinet body 10 accommodates many of the drawers 20. The biometric identification device 30, the card reader 40 and the monitoring device 50 cooperate that taking out of precise amount of precise medicine by an authorized user per the prescription is performed.

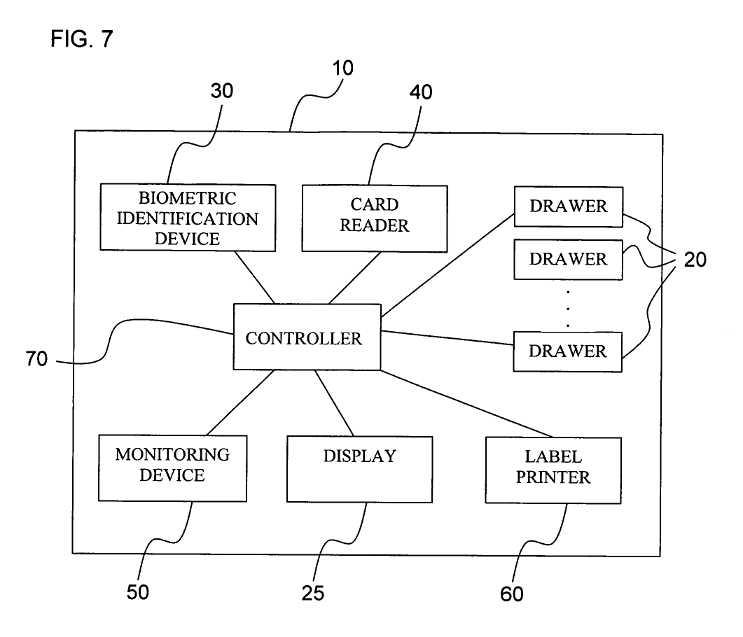

A feeding device (not shown) that moves the drawer 20 and a controller 70 (refer to FIG. 7) that controls the feeding device according to the prescription is provided in the cabinet body 10. A medicine storage 11 that stores spare medicines in a locked state is provided in the lower part of the cabinet body 10.

The drawer 20 includes a tray 21 and an actuator 22. The tray 21 carries ampoules or vials inside the receiving partition of the cabinet body 10, moves out of the front panel of the cabinet body 10 during taking in/out operation of medicine, and retracts into the cabinet body 10 after taking in/out is completed.

The biometric identification device 30 authenticates authorized user who is allowed to take out medicine. A list of authorized persons is stored in the controller 70. When an unauthorized person tries to access medicine, the movement of the drawer 20 is limited.

The card reader 40 is installed on the front panel of the cabinet body 10 and reads information of name and quantity of medicine to be taken out per the prescription from an IC card 41. After the reader 40 gets the prescription, the drawer 20 that contains the medicine specified in the prescription is moved out automatically. Then the user takes out medicine. When the taken out quantity is more than the quantity specified in the prescription, the situation is reported to the controller which issues warning to the security and the administrator.

The monitoring device 50 takes a photograph or film of a user that approaches to the cabinet body 10 and takes out medicine. The photograph or film is stored in a storage media. The monitoring device 50 has a wide angle of view.

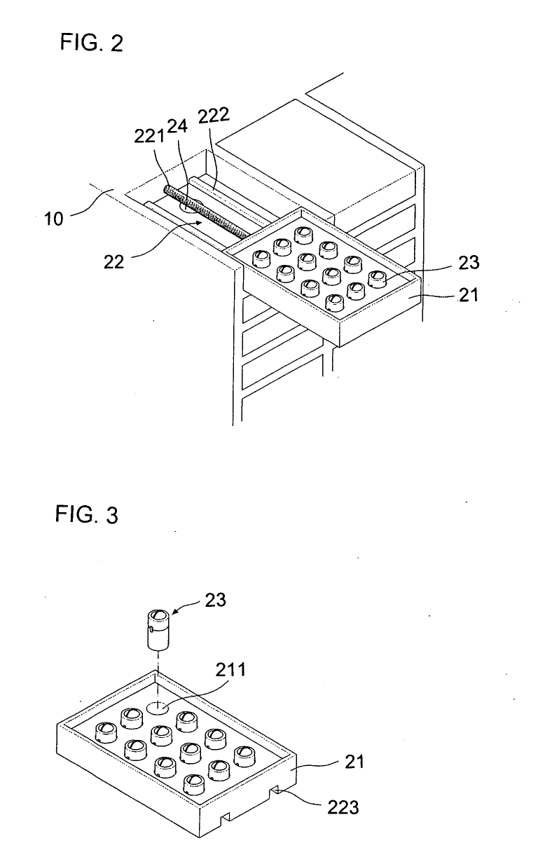

FIGS. 2-4 show the tray 21 and the actuator 22. The tray 21 has a shape of a drawer and moves backward and forward, and has a plurality of receiving recesses 211 provided and aligned on the upper portion thereof for receiving the receiving cassettes 23.

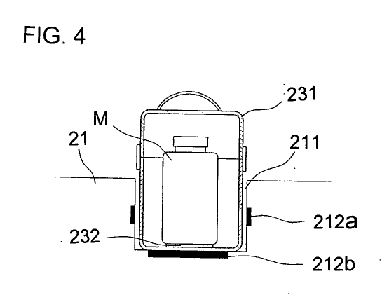

As shown well in FIG. 4, the-receiving cassette 23 includes a shell 231 and an RFID tag 232, which is attached inside the shell 231. The RFID tag 232 stores information that identifies the medicine contained in the shell 231 and indicates the expiration date of the medicine. The RFID reader 24 reads the information from the RFID tag 232 and the information thus read is displayed on a display 25 so that the user can check the consistency to prevent error.

Referring to FIG. 2, the RFID reader 24 is installed on the bottom of the receiving partition in which the tray 21 is received.

For a medicine that is difficult to attach an RFID tag, a photo sensor 212a and/or a load cell 212b is installed in the receiving recess 211 to sense taking in and out of the receiving cassette 23.

A pair of the photo sensors 212a are oppositely installed inside the receiving recess 211. When a receiving cassette is taken in, the light of one photo sensor is blocked and the other photo sensor does not sense light and a signal that indicating taking in of a receiving cassette is generated. When a receiving cassette is taken out, one photo sensor senses the light of the other photo sensor. In this way, information for taking in/out time and the name of the medicine is sent to the controller to facilitate management and monitoring of medicines.

The load cell 212b is installed on the bottom of the receiving recess 211 and measures weight change of the receiving cassette. When the load cell 212b senses weight greater than the reference weight, which is the weight of a vacant receiving cassette 23, it is considered that medicine is contained in the receiving cassette 23 and information regarding the weight increase and time of weight change is sent to the controller to facilitate managing taking in/out of important medicine.

The actuator 22 moves the tray 21 forward and backward according to the signal of the controller. The actuator 22 includes a feed screw 221. Two guides 222 are provided in the receiving partition, and engage with two guide grooves 223 provided on the bottom of the tray 21 so that the tray 21 moves along the guides 222. A rack and pinion may be provided instead of the feed screw.

The feed screw 221 is driven by a motor (not shown) that is provided in the cabinet body 10. The feed screw 221 moves the tray 21 linearly and at constant speed.

The guides 222 and the guide grooves 223 keep the tray's movement stable on a predetermined path.

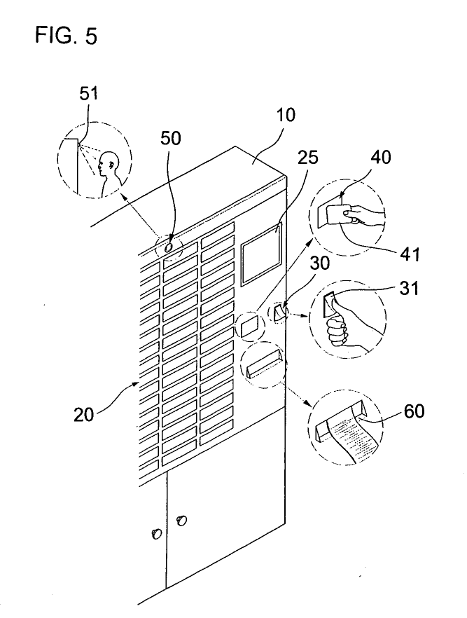

FIG. 5 shows how to use the medicine storage cabinet.

The biometric identification device 30 checks the identity of a person who tries to take out the medicine. When the person is authenticated as a valid user, the controller controls the display 25 to display guide message for the next step. Next, the user inserts the IC card 41 in which the prescription of a doctor is stored into the card reader 40. When the prescription is read and the information is sent to the controller, the drawer 20 containing medicine designated in the prescription is moved out of the cabinet body 10 automatically, and the monitoring device 50 takes a photograph or films the user, and the label printer 60 prints taking out information.

The biometric identification device 30 can check the identity of a person using the biometric of a human being. The embodiment uses a finger print recognition device 31 as the biometric identification device. Other biometric identification devices that recognize pupil, blood vessel, and face and thereby identity theft is not possible may also be used.

The prescription in the IC card 41 is input to the cabinet through the card reader 40. Only the drawer 20 that corresponds to the prescription is automatically moved out. Therefore, access to medicines other than that is prescribed is prohibited. When medicine is taken out incorrectly, for example a different medicine or different amount is taken out, an alarm is generated or a message is sent to the security and the administrator.

The card reader 40 does not operate unless the biometric identification device 30 authenticates a user as an authorized user. Therefore, if the IC card is duplicated without permit or stolen, the drawer 20 cannot be opened.

The monitoring device 50 includes a vision camera 51 that is operated by perceiving motion of a user, and records the motion. The monitoring device 50 can check whether medicine is taken out in real time, and monitors the person who takes out medicine.

The display 25 displays prescription data and the information obtained from the drawer 20 by RFID reading. The display is a LCD touch pad which can receive input during taking in and taking out.

The label printer 60 prints all or part of the information displayed by the display 25, including the user, doctor, taking out time, taking out amount, item, and patient, etc.

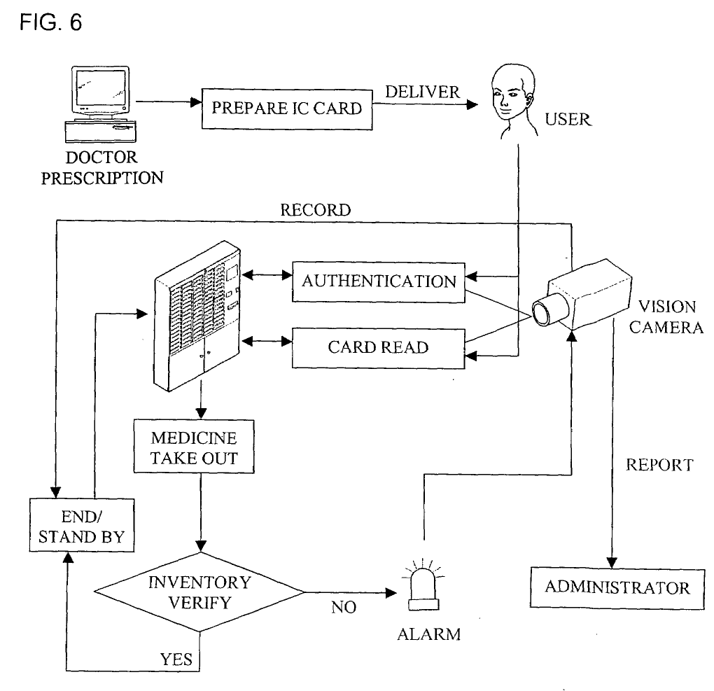

FIG. 6 is a block diagram showing the procedure of using the medicine storage cabinet.

First, a doctor inputs a prescription of medicine to a terminal. Then the contents input and identification information of an authorized user who can take out the prescribed medicine are recorded in an IC card, and the IC card is sent to the authorized user.

The authorized user inputs his or her biometric data to the biometric identification device 30. After the controller authenticates the user, the user inserts the IC card into the card reader 40. Then the drawer 20 that contains the prescribed medicine is moved out automatically and the vision camera takes photo of the user. The photo sensor and the load cell check whether correct amount of correct medicine is taken out. If incorrect amount and/or incorrect medicine is taken out, an alarm is generated and a warning message is sent to the security and the administrator.

The user receives the medicine by taking the receiving cassette 23, and separating the shell 231 and taking out the medicine inside the shell. When the tray 21 is moved, the RFID reader reads the RFID tag and information regarding the medicine including the expiration period of the medicine is displayed on the display 25 so that the user can check the information.

When the receiving cassette is taken out from the tray, a medicine stock measuring means including the photo sensor 212a and load cell 212b checks whether taking in/out of medicine is occurred and whether medicine is received in the shell 231, and records the check result. Incorrect taking out is checked immediately in this way.

The label printer 60 prints how the medicine is to be administered to the patient to prevent erroneous administration.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A medicine storage cabinet comprising:
a) a cabinet body that comprises a plurality of drawers and a front panel, wherein one or more of the drawers contain medicines;
b) a biometric identification device that authenticates identity of a user of the medicine storage cabinet;
c) an input device that receives input from an input medium that contains prescription information; and
d) a controller that validates user information provided by the biometric identification device, and controls to open the drawer that contains medicine that is prescribed in the prescription information provided by the input device.

2. The medicine storage cabinet of claim 1, wherein the biometric identification device is installed on the front panel of the cabinet body, wherein the biometric identification device comprises a finger print recognition device.

3. The medicine storage cabinet of claim 1, wherein the input device comprises a card reader and the input medium comprises an IC card.

4. The medicine storage cabinet of claim 1, wherein the drawer comprises a tray and an actuator that moves the tray, wherein the tray comprises a plurality of receiving recesses that are adapted to receive receiving cassettes.

5. The medicine storage cabinet of claim 4, wherein the receiving cassette comprises a shell that is adapted to contain medicine.

6. The medicine storage cabinet of claim 5, wherein the receiving cassette further comprises an RFID tag that records information for the medicine that is contained in the shell wherein the cabinet body further comprises an RFID reader that reads the RFID tag.

7. The medicine storage cabinet of claim 5, wherein a photo sensor is provided in the receiving recess, wherein the photo sensor checks whether the shell is received in the receiving recess.

8. The medicine storage cabinet of claim 5, wherein a load cell is provided on a bottom of the receiving recess, wherein the load cell measures the weight of the receiving cassette.

9. The medicine storage cabinet of claim 4, wherein the actuator drives a feed screw and a motor, wherein the motor rotates the feed screw, wherein the feed screw moves the tray linearly.

10. The medicine storage cabinet of claim 4, wherein the cabinet body comprises one or more guides that engage with one or more guide grooves provided on the bottom of the tray whereby the tray moves along the guides.

11. The medicine storage cabinet of claim 1, further comprising a monitoring device that takes image of the user of the medicine storage cabinet.

12. The medicine storage cabinet of claim 1, further comprising a display that is installed on the front panel of the cabinet body and displays medicine and prescription information.

13. The medicine storage cabinet of claim 1, further comprising a label printer that is installed on the front panel of the cabinet body and prints out medicine taking out information.
